(19) United States
(12) Patent Application Publication
(10) Pub. No.: US 2005/0274618 A1
(43) Pub. Date: Dec. 15, 2005

(54) Assay chip

(76) Inventors: Gwo-Bin Lee, Tainan City (TW); Che-Hsin Lin, Kaohsiung City (TW); Suz-Kai Hsiung, Kaohsiung City (TW)

Correspondence Address: CHRISTIE, PARKER & HALE, LLP, P.O. BOX 7068, PASADENA, CA, 91109-7068, US

(21) Appl. No.: 11/133,711

(22) Filed: May 21, 2005

(30) Foreign Application Priority Data
Jun. 15, 2004 (TW) 093117170

(51) Int. Cl. G01N 27/26

(52) U.S. Cl. 204/601; 204/403.01

(57) ABSTRACT

An assay chip includes a microchannel unit formed in a substrate. The microchannel unit includes a sample channel having inlet and outlet ends, a detection channel which intersects the sample channel and has an injection end and a recycle end on two opposite sides of the sample channel, respectively, and at least one light-exciting channel and at least one light-sensing channel disposed respectively adjacent to two opposite sides of the detection channel between the recycle end and the sample channel. A sensor unit includes first and second optical fibers inserted respectively into the light-exciting and light-sensing channels.

### CROSS-REFERENCE TO RELATED APPLICATION

This application claims priority from Taiwanese Patent Application No. 93117170, filed on Jun. 15, 2004.

### BACKGROUND OF THE INVENTION

1. Field of the Invention

This invention relates to an assay device, more particularly to an assay device for analyzing a fluorescent dye-labeled sample and for identifying the labeled components contained in the sample.

2. Description of the Related Art

In the field of biomedical diagnosis, capillary electrophoresis technology has been widely used to detect various biological samples. Microcapillary electrophoresis chips fabricated through MEMS (micro electro mechanical system) technology have become much more popular due to the advantages of high separation efficiency, susceptibility to miniaturization, less sample fluid consumption, and higher sensitivity, compared to the conventional capillary electrophoresis apparatuses. However, conventional laser induced fluorescence (LIF) devices developed by MEMS (micro electro mechanical system) technology require mercury lamps and associated band pass filters for using as an excitation light source, and the generation of fluorescence signals must utilize a lenses assembly disposed inside a spectroscope for focusing and transmitting fluorescence signals to a fluorescence detecting unit. Since the aforesaid devices occupy substantial space, miniaturization is impossible for conventional capillary electrophoresis devices. Integrating an optical detection mechanism into a microcapillary electrophoresis chip is demanding for miniaturization of capillary electrophoresis systems and for parallel detection of multiple samples.

The prior art has suggested an integration of the micro capillary electrophoresis chip with an optical detection mechanism by installing an optical detection apparatus such as a PD or avalanche PD, on a sample flow channel of a micro capillary electrophoresis chip. However, such a method is complicated and expensive and therefore is not suitable for the production of disposable biomedical detection chips.

On the other hand, due to limitation of the construction of the conventional capillary electrophoresis devices, the currently available assay methods permit detection of only one type of component contained in a sample in one test. Therefore, several tests must be conducted when two or more than two components contained in a sample have to be identified, thereby increasing the time and costs required for analyzing a sample.

### SUMMARY OF THE INVENTION

An object of the present invention is to provide an assay chip which includes optical fibers incorporated into a microchannel unit.

Another object of the present invention to provide an assay chip through which several components contained in a sample can be identified in parallel.

According to the present invention, an assay chip comprises a substrate; and a microchannel unit formed in the substrate. The microchannel unit includes: a sample channel which has an inlet end and an outlet end; a detection channel which intersects the sample channel and which has an injection end and a recycle end on two opposite sides of the sample channel respectively; at least one light-exciting channel which has a light-receiving end and a light-emanating end that is disposed adjacent to the detection channel between the recycle end and the sample channel; and at least one light-sensing channel which has a signal-receiving end, and a signal-sending end disposed adjacent to the detection channel between the recycle end and the sample channel. All of the inlet and outlet ends, the injection end, the recycle end, the light-receiving end, and the signal-sending end extend to an outside of the substrate. The assay chip further includes a sensor unit which includes a first optical fiber inserted into the light-exciting channel, and a second optical fiber inserted into the light-sensing channel.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded view of an assay chip embodying the present invention;

FIG. 2 is a plan view of a lower plate of the assay chip;

FIG. 3 is a diagram showing the results of a test using the assay chip;

FIG. 4 is a diagram showing the results of another test using the assay chip;

FIG. 5 is a diagram showing the results of still another test using the assay chip;

FIG. 6 is a diagram showing the results of yet another test using the assay chip;

FIG. 7 is a perspective view showing a structure for making a mold plate for forming a lower plate of the assay chip;

FIG. 8 is a perspective view showing the mold plate formed with a molding pattern;

FIG. 9 shows the lower plate which is to be molded by the mold plate;

FIG. 10 shows that the lower plate is formed with the microchannel unit; and

FIG. 11 shows that the lower plate is coupled with an upper plate.

### DETAILED DESCRIPTION OF THE PREFERRED EMBODIMENTS

Before the present invention is described in greater detail, it should be noted that same reference numerals have been used to denote like elements throughout the specification.

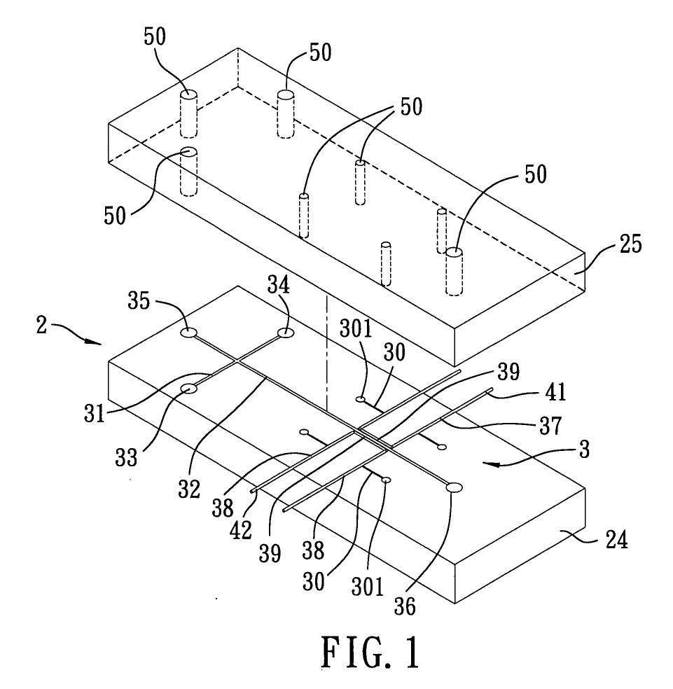

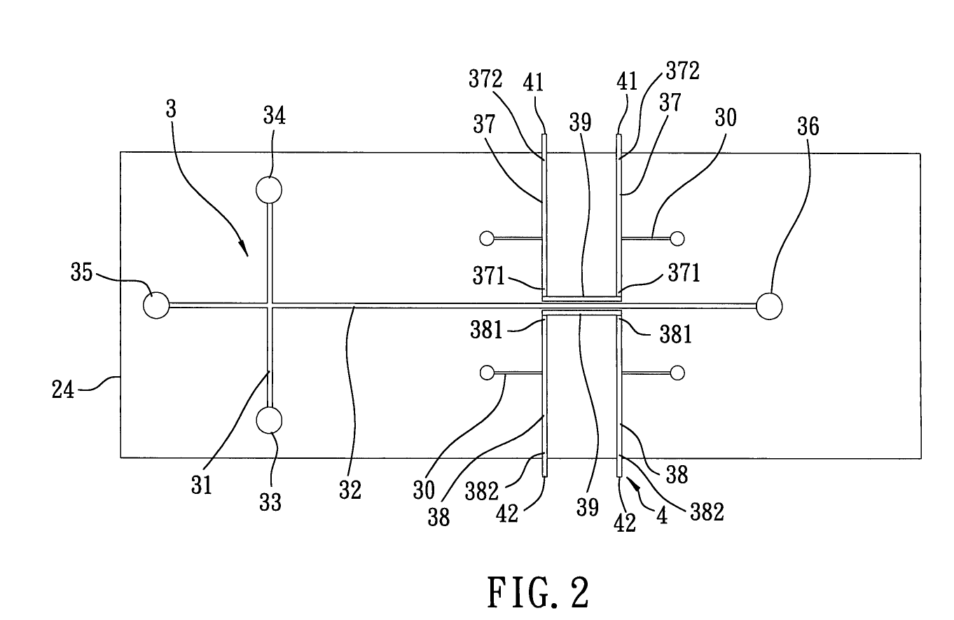

Referring to FIGS. 1 and 2, there is shown an assay chip embodying the present invention which is useful for analyzing a fluorescenct dye-labelled sample and for identifying fluorescence substances present in the sample. The assay chip includes a substrate 2, a microchannel unit 3 formed in the substrate 2, and a sensor unit 4 inserted into the microchannel unit 3.

The substrate 2 in this embodiment is preferably made of a light transmissive material, such as polymethyl methacrylate (PMMA). However, the material of the substrate 2 should not be limited thereto according to the present invention.

The microchannel unit 3 includes a sample channel 31 and a detection channel 32 which intersects perpendicularly to the sample channel 31. The sample channel 31 includes an inlet end 33 and an outlet end 34, and the detection channel 32 has an injection end 35 and a recycle end 36 on two sides of the sample channel 31, respectively. Two substantially parallel light-exciting channels 37 are disposed transversely at one side of the detection channel 32 between the recycle end 36 and the intersection of the sample channel 31 and the detection channel 32, and two substantially parallel light-sensing channels 38 are disposed transversely at the other side of the detection channel 32 between the recycle end 36 and the intersection of the sample channel 31 and the detection channel 32. Each light-exciting channel 37 has a light-emanating end 371 disposed adjacent to the detection channel 32 and a light-receiving end 372 extending to the outside of the substrate 2. Each light-sensing channel 38 has a signal-receiving end 381 disposed adjacent to the detection channel 32, and a signal-sending end 382 extending to the outside of the substrate 2. Each light-exciting channel 37 is aligned with one of the light-sensing channels 38 in a direction transverse to the detection channel 32.

The sensor unit 4 includes two first optical fibers 41 each of which is inserted into one of the light-exciting channels 37, and two second optical fibers 42 each of which is inserted into one of the light-sensing channels 38.

While two light-exciting channels 37 and two light-sensing channels 38 are shown in this embodiment, the quantity thereof maybe increased or decreased depending on the number of the fluorescent dye-labeled components contained in the sample.

There are two medium channels 39 extending along and adjacent to the detection channel 32. One of the medium channels 39 is connected fluidly to the light-emanating ends 371 of the light-exciting channels 37, while the other medium channel 39 is connected fluidly to the signal-receiving ends 381 of the light-sensing channels 38. Medium filling holes 301 are used to fill the light-exciting and light-sensing channels 37, 38 with an index-matching medium through medium filling channels 30. The index-matching medium is used to fill all of the light-exciting and light-sensing channels 37, 38 through the medium channels 39.

There are clearances between the inner wall of the detection channels 32, the light-exciting channels 37 and the light-sensing channels 38 and the outer wall of the first and second optical fibers 41, 42 after the first and second optical fibers 41, 42 are inserted respectively into the light-exciting and light-sensing channels 37, 38. Due to such clearances, an exciting light passing therethrough can be dispersed and attenuated, and the strength of fluorescence signals produced thereby can thus be reduced. The index-matching medium introduced into the light-exciting and light-sensing channels 37, 38 serve to reduce the effect of light dispersion and attenuation and to improve the strength of the fluorescence light signals. One example of the index-matching medium is an alcohol.

The sample channel 31 is used to receive the fluorescent dye-labeled sample, whereas the detection channel 32 is used to receive a buffer solution. When a voltage is applied between the inlet end 33 and the outlet end 34, the voltage named as an injection voltage and an electro-osmotic force will drive the sample to flow from the inlet end 33 to the outlet end 34 along the sample channel 31. When another voltage is applied between the injection end 35 and the recycle end 36, the voltage named as a separating voltage and an electro-osmotic force will drive the sample to flow from the injection end 35 to the recycle end 36 along the detection channel 32.

In operation, an injection voltage is first applied between the inlet and outer ends 33, 34 so that the sample flows in the sample channel 31 for a period. Then, the injection voltage is stopped, and a separation voltage is applied between the injection and recycle ends 35, 36 so that the sample flows from the injection end 35 to the recycle end 36. Since a small portion of the sample flows into the detection channel 32, a large portion of the sample can be recycled from the outlet end 34. The amount of the sample required to be tested is thus reduced, thus lowering costs. Due to different electron-carrying properties and different electro-osmotic mobilities of the fluorescent dyes present in the sample, the components labeled by the fluorescent dyes can be separated through different electro-osmotic flows. As such, different components contained in the sample can be identified at the same time.

The first optical fibers 41 function to transmit light beams having different wavelengths into the detection channel 32 to irradiate the fluorescent dye-labeled sample. When the fluorescent dye-labeled components contained in the sample are irradiated in the detection channel 32, they will generate respective fluorescence signals, and the fluorescence signals will be collected by the respective second optical fibers 42 at the signal-receiving ends 381 of the light-sensing channels 38. The fluorescence light signals are sent out of the substrate 2 at the signal-sending ends 382 of the light-sensing channels 38 and are then converted into voltage signals. Different wavelengths of the light sources are used to excite the different fluorescent dye-labeled components contained in the sample, and the fluorescence signals generated by the fluorescent dyes are sent out of the substrate 2 through the respective second optical fibers 42. As such, the components labeled by the fluorescent dyes may be detected and identified through the second optical fibers 42. As two light-exciting channels 37 and two light-sensing channels 38 are provided in the substrate 2, two components contained in the sample may be identified in this embodiment. The number of the light-exciting and light-sensing channels 37, 38 may be increased, if more than two components contained in the sample are to be identified.

Application of the assay chip of the present invention is exemplified as follows:

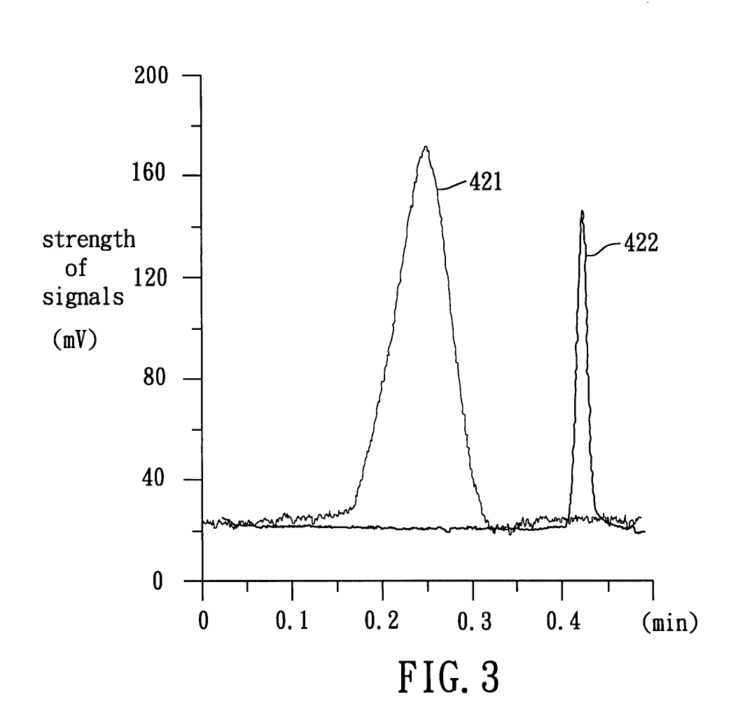

In one example, two different fluorescence dyes were used to prepare a sample to be tested; one of the dyes was Rhodamine B which can be excited by a green light, and the other was fluorescein isothiocyanate (FITC) which can be excited by a blue light. The sample was prepared by mixing the two dyes and by diluting the same with a buffer solution. The sample was injected into the sample channel 31. The buffer solution per se was injected into the detection channel 32 through the injection end 35. The two optical fibers 41 of the sensor unit 4 were used to transmit respectively green and blue light. A voltage of 800V was applied between the inlet and outlet ends 33 and 34 for 30 seconds, and a voltage of 1200V was applied between the injection end 35 and the recycle end 36 for 80 seconds. At this time, the sample flow flowed from the injection end 35 to the recycle end 36 along the detection channel 32. When the sample moved past the light-exciting and light-sensing channels 37, 38, it was illuminated by the green and blue light and the two dyes present in the sample were detected. The test results are shown in FIG. 3, wherein plot 421 represents voltage signals which were converted from fluorescence signals of Rhodamine B, and plot 422 represents voltage signals which were converted from fluorescence signals of fluorescein isothiocyanate. The peaks of the plots 421, 422 reflect that the aforesaid two dyes were successfully separated and detected by the two optical fibers 42 of the sensor unit 4.

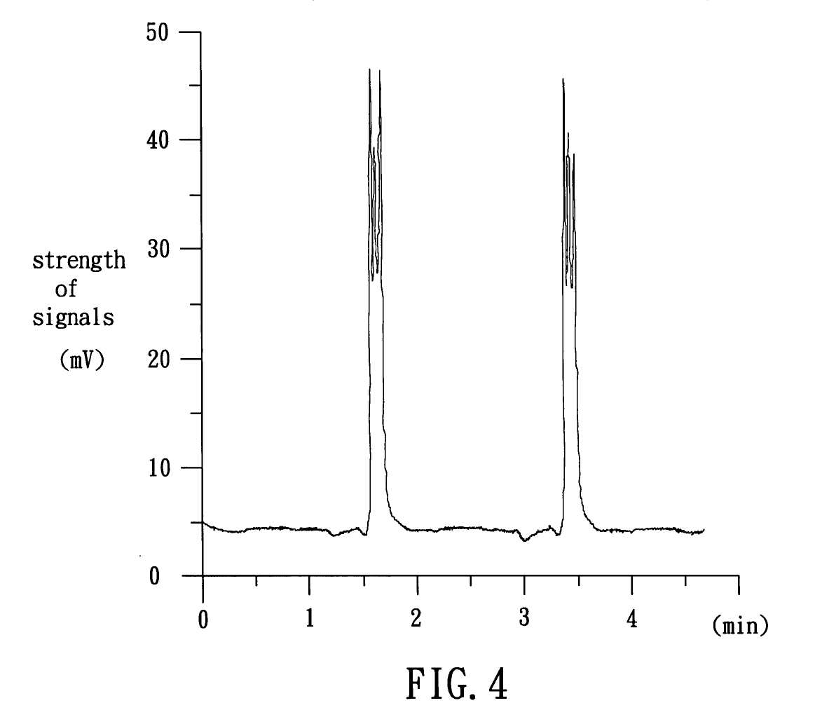

FIG. 4 shows a diagram obtained from an analysis of DNA (a biotinylated DNA primer, 12 base, single strand) using the assay chip of the present invention. The DNA labeled with a dye was introduced into the sample channel 31 and was subjected to examination in the detection channel 32 of the assay chip. FIG. 4 shows that the optical fibers 42 of the sensor unit 4 have successfully detected two peak voltage signals at two different times.

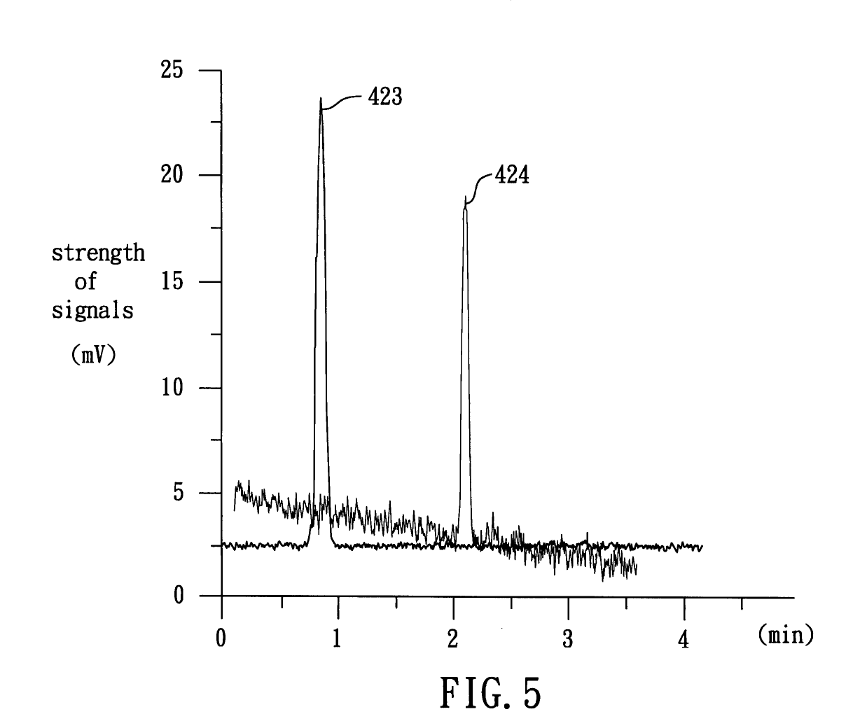

FIG. 5 shows a diagram obtained from an analysis on protein (bovine serum albumin, BSA) labeled with two fluorescence dyes using the assay chip of the present invention. Two portions of the protein were respectively labeled with two fluorescence dyes, i.e. FITC and Cy5, and the two portions were mixed together and introduced into the sample channel 31. Data obtained after illumination using green and blue light beams transmitted through the second optical fibers 42 are shown in FIG. 5 in terms of plots 423, 424. Plot 423 represents signals that identify FITC, whereas plot 424 represents signals that identify CY5. The apparent peaks of the plots 423, 424 show that the protein labeled with two different fluorescence dyes can be analyzed by the assay chip of the present invention.

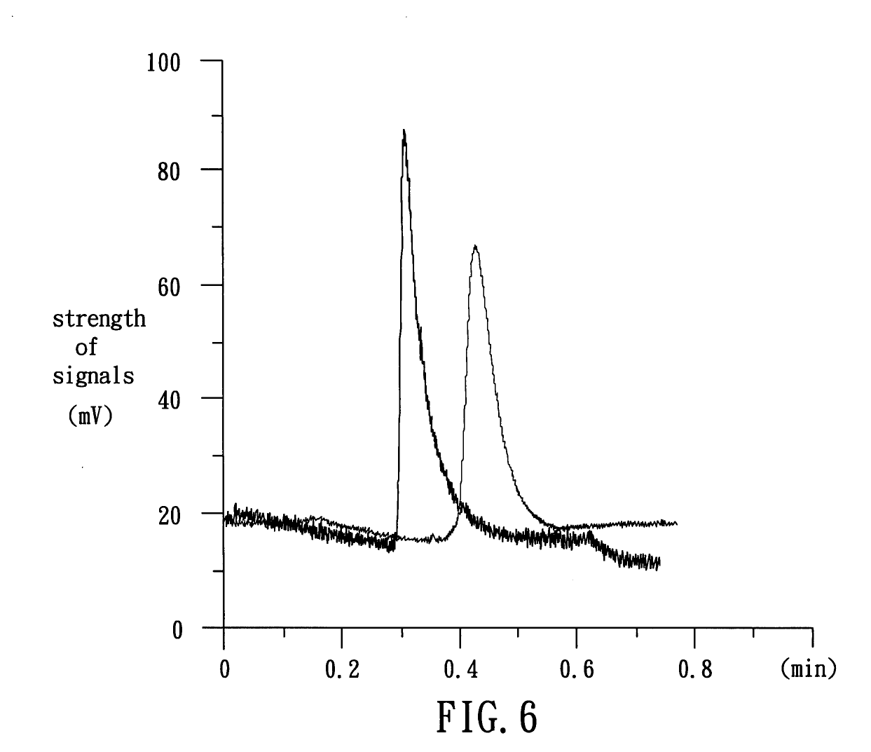

The assay chip may be used to determine the flow rate of a component contained in a sample which flows in the detection channel 32. In an example, a sample component was labeled with a fluorescent dye (FITC). A blue light was transmitted through the two first optical fibers 41 at the same time. A dye labeled sample passed through the first and second optical fibers 41, 42. The fluorescence signals generated through the second optical fibers 42 are shown in FIG. 6. In FIG. 6, the time required for the labeled component to pass through the two second optical fibers 42 may be read from the distance between the peaks of the two plots. The distance between the two second optical fibers 42 may be obtained through measurement. The flow rate of the labeled component may be calculated based on the aforesaid distances.

Referring once again to FIG. 1, the substrate 2 of the assay chip according to the present invention is preferably composed of a lower plate 24 and an upper plate 25. The assay chip may be fabricated as follows:

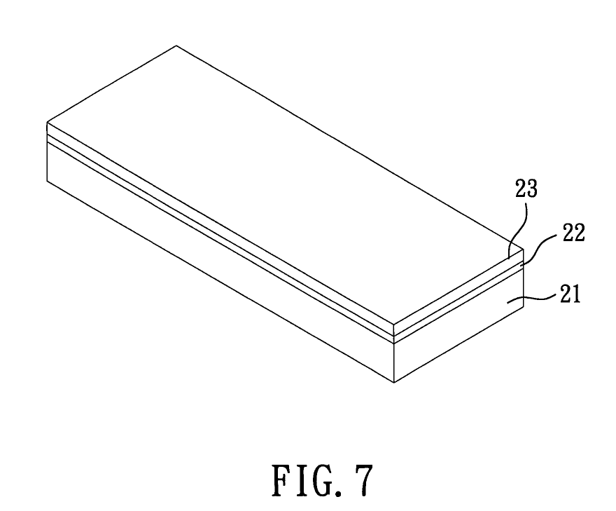

(a) A metal layer 22, such as, a chromium layer, is deposited on a glass or quartz mold plate 21, and a photoresist 23 is applied to the metal layer 22, as shown in FIG. 7.

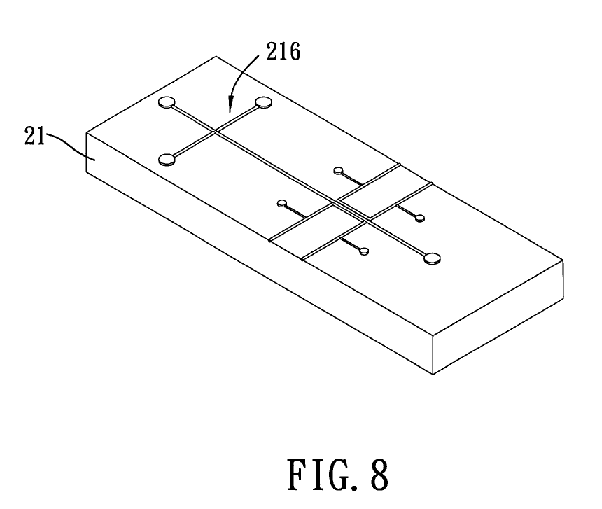

(b) A pattern conforming to the profile of the microchannel unit 3 is prepared by micro lithography technology and is transfer-printed on the photoresist 23. After acidic etching, the metal layer 22 is patterned. By using the patterned metal layer 22 as a shield, the mold plate 21 is etched, thereby forming a molding projection 216 on the mold plate 21, as shown in FIG. 8.

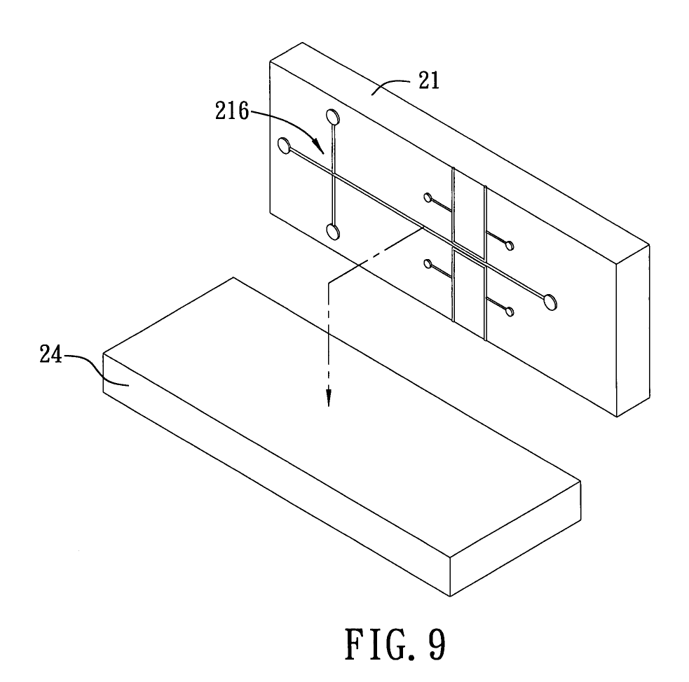

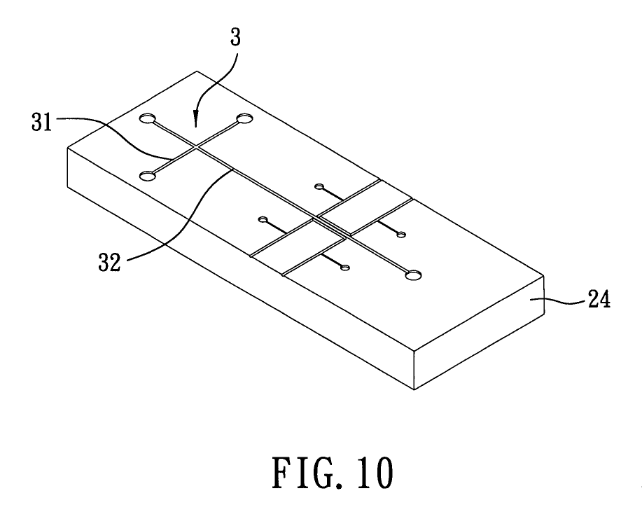

(c) Referring to FIGS. 9 and 10, the pattern of the molding projection 216 is transfer-printed on the top surface of a lower plate 24 made of a transparent thermoplastic material so that the top surface of the lower plate 24 is formed with the microchannel unit 3. Two transfer-printing methods may be used to form the microchannel unit 3 on the lower plate 24. One of the methods is to heat the top surface of the lower plate 24 and to press the mold plate 21 against the heated top surface of the lower plate 24. The other method is to form the lower plate 24 over the mold plate 21 by applying a melt of transparent thermoplastic material to the surface of the mold plate 21 and over the molding projection 216. When the melt is cooled and removed from the mold plate 21, the lower plate 24 with the microchannel unit 3 is formed.

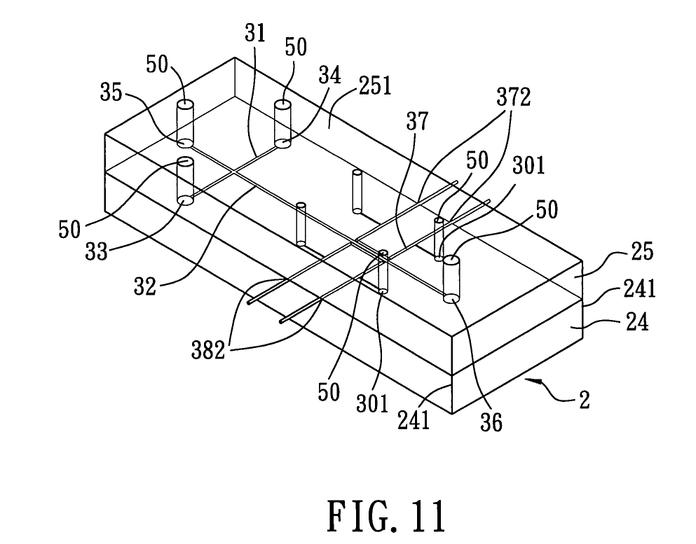

(d) Referring to FIG. 11, the upper plate 25 is made from a transparent plastic material and is drilled to form through holes 50 which can be aligned respectively with the inlet and outlet ends 33, 34, the injection and recycle ends 35, 36 and the filling holes 301 of the lower plate 24.

(e) The upper plate 25 is overlaid on and coupled with the lower plate 24 in such a manner that the inlet, outlet, injection, recycle, and filling holes 33, 34, 35, 36 and 301 are aligned properly with the respective through holes 50.

(f) First and second optical fibers 41, 42 are inserted respectively into the light-exciting and light-sensing channels 37, 38 and are fixed thereto by UV curable glue. As shown in FIG. 11, after the lower and upper plates 24 and 25 are coupled together, the microchannel unit 3 is covered by the upper plate 25. The through holes 50 open at a top face 251 of the upper plate 25. The lower plate 24 has two opposite lateral sides 241 which extend transversely of the top face 251 of the upper plate 25. The light-receiving ends 372 open at one of the lateral sides 241, and the signal-sending ends 382 open at another lateral side 241.

Through the above method, the assay chip according to the present invention may be mass-produced at a high production rate and at low costs. The assay chip has a simple construction and can be produced with a high yield of good quality products. Furthermore, the assay chip is inexpensive and disposable. Moreover, analysis of samples can be made easy and efficient by using the assay chip of the present invention.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. An assay chip comprising:
a substrate;
a microchannel unit formed in said substrate and including a sample channel which has an inlet end and an outlet end, a detection channel which intersects said sample channel and which has an injection end and a recycle end on two opposite sides of said sample channel, at least one light-exciting channel which has a light-receiving end, and a light-emanating end that is disposed adjacent to said detection channel between said recycle end and said sample channel, and at least one light-sensing channel which has a signal-receiving end, and a signal-sending end disposed adjacent to said detection channel between said recycle end and said sample channel, all of said inlet and outlet ends, said injection end, said recycle end, said light-receiving end, and said signal-sending end extending to an outside of said substrate; and
a sensor unit including a first optical fiber inserted into said light-exciting channel, and a second optical fiber inserted into said light-sensing channel.

2. The assay chip as claimed in claim 1, wherein said light-exciting channel and said light-sensing channel are respectively disposed on two opposite sides of said detection channel and are aligned with each other along a line transverse to said detection channel.

3. The assay chip as claimed in claim 2, wherein said microchannel unit includes a plurality of said light-exciting channels, a plurality of said light-sensing channels, a plurality of said first optical fibers inserted respectively into said light-exciting channels, and a plurality of said second optical fibers inserted respectively into said light-sensing channels.

4. The assay chip as claimed in claim 3, wherein said light-exciting channels are parallel to each other, and said light-sensing channels are parallel to each other.

5. The assay chip as claimed in claim 3, wherein said microchannel unit further includes a first medium channel which extends adjacent to said detection channel and intercommunicates said light-emanating ends of said light-exciting channels, a second medium channel which extends adjacent to said detection channel and intercommunicates said signal-receiving ends of said light-sensing channels, and an index-matching medium introduced into said first and second medium channels, said light-exciting channels, and said light-sensing channels.

6. The assay chip as claimed in claim 5, wherein said index-matching medium is an alcohol.

7. The assay chip as claimed in claim 1, wherein said microchannel unit is formed by microlithography and etching processes.

8. The assay chip as claimed in claim 7, wherein said substrate is transparent.

9. The assay chip as claimed in claim 8, wherein said substrate includes a lower plate, and an upper plate which overlies said lower plate, said microchannel unit being entirely formed in said lower plate and being covered by said upper plate, said upper plate including a top face, and a plurality of through holes which are respectively and fluidly communicated with said inlet and outlet ends, said injection end, and said recycle end, and all of which open at said top face, said lower plate having two opposite lateral sides which extend transversely of said top face of said upper plate, said light-receiving end and said signal-sending end opening respectively at said lateral sides.
